(19) United States
(12) Patent Application Publication
(10) Pub. No.: US 2019/0340637 A1
(43) Pub. Date: Nov. 7, 2019

(54) SERVER SYSTEM, CONTROL METHOD, AND NON-TRANSITORY COMPUTER-READABLE MEDIUM STORING PROGRAM

(71) Applicant: TOYOTA JIDOSHA KABUSHIKI KAISHA, Toyota-shi (JP)

(72) Inventors: Takashige HORI, Aisai-shi (JP); Katsunori TAKAMI, Tachikawa-shi (JP)

(73) Assignee: TOYOTA JIDOSHA KABUSHIKI KAISHA, Toyota-shi (JP)

(21) Appl. No.: 16/381,036

(22) Filed: Apr. 11, 2019

(30) Foreign Application Priority Data
May 7, 2018 (JP) 2018-089451

(51) Int. Cl. G06Q 30/02; G06Q 10/02; G06Q 50/30

(52) U.S. Cl. CPC G06Q 30/0236; G06Q 10/02; G06Q 50/30; G06Q 30/0238; G06Q 30/0213

(57) ABSTRACT

A server system includes a communication unit, a storage unit, and a control unit. The control unit is configured to store reservation information of a vehicle to be used by a first user, receive, from a first terminal device, coupon information showing the content of a coupon to be granted to a passenger who will share a ride in the vehicle with the first user, deliver, to one or more terminal devices, a passenger recruitment notification including the coupon information, transmits a ride-sharing application notification to the first terminal device upon receiving a request for transmission of the ride-sharing application notification from a second terminal device among one or more terminal devices, and add, to the reservation information, a user ID of a second user of the second terminal device as a user ID of a passenger who will share a ride in the vehicle with the first user.

### INCORPORATION BY REFERENCE

The disclosure of Japanese Patent Application No. 2018-089451 filed on May 7, 2018 including the specification, drawings and abstract is incorporated herein by reference in its entirety.

### BACKGROUND

### 1. Technical Field

The present disclosure relates to a server system, a control method, and a non-transitory computer-readable medium storing a program.

### 2. Description of Related Art

Recently, ride-sharing, in which a plurality of users share a ride in one vehicle, has become popular. For example, Japanese Unexamined Patent Application Publication No. 2003-044702 discloses a ride-sharing mediation management apparatus which mediates between a travelling vehicle carrying a user and a passenger who will share a ride with the user, by searching, via a communication network, for information of candidate passengers having ride information including a riding place which is close to the user and selecting a candidate passenger who can share the ride in a similar travelling direction by further referring to the ride information including a destination.

### SUMMARY

Advantages of ride-sharing can include, for example, reducing traffic, saving fuel, and decreasing air pollution. The above-described related art, however, does not necessarily promote the ride-sharing. For example, a ride-sharing service user may be reluctant to share a ride in a vehicle with an unspecified stranger.

The present disclosure provides a server system, a control method, and a non-transitory computer-readable medium storing a program that promotes ride-sharing of a vehicle.

A server system according to a first aspect of the present disclosure includes a communication unit including one or more communication modules, a storage unit including one or more memories, and a control unit including one or more processors. The control unit is configured to store, in the storage unit, reservation information of a vehicle to be used by a first user, receive, from a first terminal device of the first user via the communication unit, coupon information showing the content of a coupon to be granted to a passenger who will share a ride in the vehicle with the first user, deliver, to one or more terminal devices via the communication unit, a passenger recruitment notification including the coupon information, transmit a ride-sharing application notification to the first terminal device via the communication unit upon receiving a request for transmission of the ride-sharing application notification from a second terminal device among the one or more terminal devices via the communication unit, and add, to the reservation information, a user ID of a second user of the second terminal device as a user ID of the passenger who will share the ride in the vehicle with the first user.

The control unit may add the user ID of the second user to the reservation information upon transmitting the ride-sharing application notification to the first terminal device and receiving a request for acceptance from the first terminal device via the communication unit.

The control unit may transmit one or more pieces of coupon information to the first terminal device via the communication unit. The coupon information received from the first terminal device may be selected based on an input of the first user to the first terminal device from among the one or more pieces of coupon information.

The one or more pieces of coupon information may be extracted from among a plurality of pieces of coupon information, based on at least one of a destination of the first user when using the vehicle, a reservation period of the vehicle, and personal information of the first user.

The coupon information received from the first terminal device and the coupon shown in the coupon information may be generated based on the input of the first user to the first terminal device.

The control unit may transmit, to the first terminal device via the communication unit, a request for payment of a generation fee of the coupon information to the first user.

According to completion of a process of payment of a vehicle use fee based on the reservation information, the control unit may grant, to the second user, the coupon corresponding to the coupon information included in the recruitment notification.

A control method according to a second aspect of the present disclosure is a method of controlling a server system configured to communicate with a plurality of terminal devices. The control method includes a step of storing reservation information of a vehicle to be used by a first user, a step of receiving, from a first terminal device of the first user, coupon information showing the content of a coupon to be granted to a passenger who will share a ride in the vehicle with the first user, a step of delivering, to one or more terminal devices, a passenger recruitment notification including the coupon information, a step of transmitting a ride-sharing application notification to the first terminal device upon receiving a request for transmission of the ride-sharing application notification from a second terminal device among the one or more terminal devices, and a step of adding, to the reservation information, a user ID of a second user of the second terminal device as a user ID of the passenger who will share the ride in the vehicle with the first user.

A non-transitory computer-readable medium according to a third aspect of the present disclosure stores a program causing a terminal device to execute a process. The terminal device includes a communication unit including one or more communication modules, an output unit including one or more output interfaces configured to output information in the form of video or audio, an input unit including one or more input interfaces configured to detect an input of a user, and a control unit including one or more processors. The process includes a step of transmitting, to a vehicle reservation system, reservation information of a vehicle according to the input of the user, a step of transmitting, to the vehicle reservation system, coupon information showing the content of a coupon to be granted to a passenger who will share a ride in the vehicle with the user of the terminal device, and a step of outputting a ride-sharing application notification in the form of video or audio, upon receiving the ride-sharing application notification transmitted by the vehicle reservation system in response to a request for transmission from a second terminal device that has received a passenger recruitment notification including the coupon information from the vehicle reservation system.

With each aspect of the present disclosure, it is possible to promote ride-sharing of a vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a terminal device, a vehicle reservation system, and a coupon management system according to one embodiment of the present disclosure;

FIG. 2 is a block diagram schematically illustrating a configuration of the terminal device;

FIG. 3 is a block diagram schematically illustrating a configuration of the vehicle reservation system;

FIG. 4 is a table illustrating information stored in a user information database;

FIG. 5 is a table illustrating information stored in a vehicle information database;

FIG. 6 is a table illustrating information stored in a reservation information database;

FIG. 7 is a block diagram schematically illustrating a configuration of the coupon management system;

FIG. 8 is a table illustrating information stored in a coupon database;

FIG. 9 is a sequence diagram illustrating a first operation of the terminal device and an information processing system;

FIG. 10 is a sequence diagram illustrating a second operation of the terminal device and the information processing system;

FIG. 11 is a sequence diagram illustrating a third operation of the terminal device and the information processing system; and

FIG. 12 is a sequence diagram illustrating a fourth operation of the terminal device and the information processing system.

### DETAILED DESCRIPTION OF EMBODIMENTS

Hereinafter, an embodiment of the present disclosure will be described.

Configuration of Information Processing System

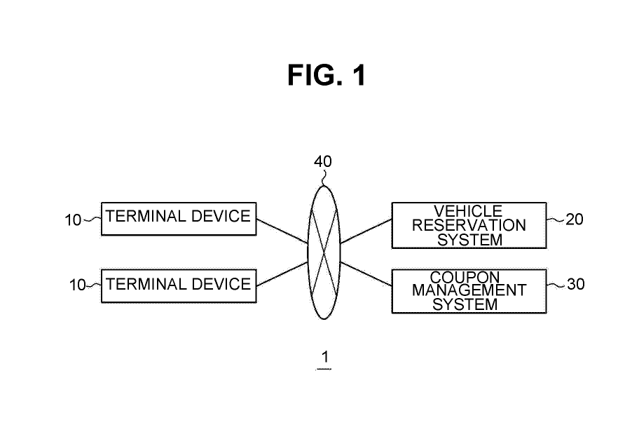

With reference to FIG. 1, an overview of an information processing system 1 according to one embodiment of the present disclosure will be described. The information processing system 1 includes a plurality of terminal devices 10, a vehicle reservation system 20, and a coupon management system 30. Each terminal device 10, the vehicle reservation system 20, and the coupon management system 30 are communicatively connected to a network 40. The network 40 includes, for example, a mobile communication network and the Internet, but is not limited thereto, and may include any communication network. In the present embodiment, each terminal device 10, the vehicle reservation system 20, and the coupon management system 30 are used in a vehicle-sharing service in which a user reserves and uses a shared vehicle.

The terminal device 10 is any electronic equipment used by the user. The terminal device 10 may be, for example, general-purpose electronic equipment, such as a smartphone, a tablet terminal, or a Personal Computer (PC), or may be electronic equipment dedicated to the information processing system 1. Although FIG. 1 illustrates two terminal devices 10 for convenience of description, the information processing system 1 may include two or more terminal devices 10. The user can access the vehicle reservation system 20 and reserve the vehicle, using the terminal device 10.

The vehicle reservation system 20 is a server system that includes one server apparatus, or a plurality of server apparatuses which are able to communicate with one another. The vehicle reservation system 20 simultaneously receives a reservation for the vehicle from a user of the terminal device 10 and manages reservation information of each vehicle.

The coupon management system 30 is a server system that includes one server apparatus, or a plurality of server apparatuses which are able to communicate with one another. The coupon management system 30 manages a coupon registered by a coupon registrant, such as a store or an event organizer. In the present embodiment, the coupon may include an electronic coupon and advertisement information. The user granted with the coupon can receive a benefit corresponding to the coupon by using the corresponding coupon. The benefit may include, for example, a discount on the price of goods or services, but is not limited thereto, and may be discretionarily determined.

In the present embodiment, a first user who has reserved the vehicle can recruit a passenger who will share a ride in the corresponding vehicle. For example, a passenger recruitment notification is pushed to a plurality of users who use the vehicle-sharing service. Thereafter, the first user and a second user who has applied for the corresponding recruitment can use the reserved vehicle by ride-sharing.

When recruiting the passenger, the first user selects coupon information he or she desires from among one or more pieces of coupon information showing the content of a coupon stored in the coupon management system 30. The coupon information selected by the first user is presented, together with the passenger recruitment notification, to the plurality of users who use the vehicle-sharing service. Thereafter, the coupon corresponding to the coupon information selected by the first user is granted to the second user who has applied for the passenger recruitment.

With the above configuration, since a coupon is granted to the second user who has applied for the passenger recruitment, the user who receives the passenger recruitment notification can be incentivized to apply for the corresponding passenger recruitment. Accordingly, ride-sharing of the vehicle is promoted. Further, since the first user who recruits the passenger selects the coupon information, which is presented, together with the passenger recruitment notification, to the plurality of users who use the vehicle-sharing service, a possibility increases that a user having a hobby and preference similar to the first user will apply for the recruitment, by selecting, for example, a coupon that matches his or her hobby and preference. Thus, for example, the first user, who may be reluctant to share a ride with an unspecified user whose hobby and preference are not known, can be incentivized to recruit a passenger. Accordingly, the ride-sharing of the vehicle is further promoted. In addition, since the coupon information is pushed, together with the passenger recruitment notification, to a plurality of users, the users have more opportunities to acquire a coupon about which the corresponding users did not previously know, and as such, the use of the vehicle-sharing service and the ride-sharing are promoted.

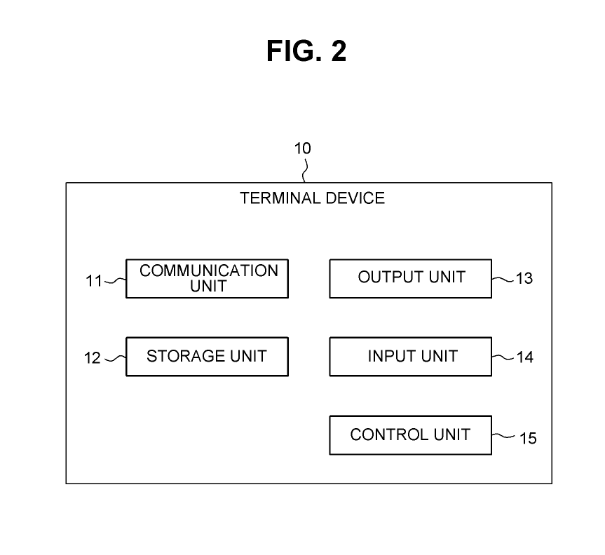

Next, with reference to FIG. 2 to FIG. 4, each configuration of the information processing system 1 will be described in detail.

Configuration of Terminal Device

As illustrated in FIG. 2, the terminal device 10 includes a communication unit 11, a storage unit 12, an output unit 13, an input unit 14, and a control unit 15.

The communication unit 11 includes a communication module connected to the network 40. For example, the communication unit 11 may include a communication module corresponding to a mobile communication standard, such as Fourth Generation (4G) or Fifth Generation (5G) mobile communication. In the present embodiment, the terminal device 10 is connected to the network 40 via the communication unit 11.

The storage unit 12 includes one or more memories. In the present embodiment, a “memory” is, but not limited to, for example, a semiconductor memory, a magnetic memory, or an optic memory. Each memory included in the storage unit 12 may function as, for example, a primary storage device, a secondary storage device, or a cache memory. The storage unit 12 stores any information used for an operation of the terminal device 10. For example, the storage unit 12 may store a system program, an application program, and a user ID of a user who uses a subject device. The user ID is information with which the user can be uniquely identified. The information stored in the storage unit 12 may be updated with, for example, information acquired from the network 40 via the communication unit 11.

The output unit 13 includes one or more output interfaces that output information to the user. For example, the output interface included in the output unit 13 is, but not limited to, a panel display that outputs information in the form of video or a speaker that outputs information in the form of audio. In the present embodiment, an “output of information in the form of video” includes displaying the corresponding information as text, a still image, a moving image, or the like.

The input unit 14 includes one or more input interfaces that detect the input of the user. For example, the input interface included in the input unit 14 is, but not limited to, a physical key, a capacitive key, a touch screen integrally installed with the panel display of the output unit 13, or a microphone that receives an audio input.

The control unit 15 includes one or more processors. In the present embodiment, a “processor” is, but not limited to, a general-purpose processor, or a processor dedicated to a specific process. The control unit 15 controls overall operation of the terminal device 10. Details of operations of the terminal device 10 controlled by the control unit 15 will be described below.

Configuration of Vehicle Reservation System

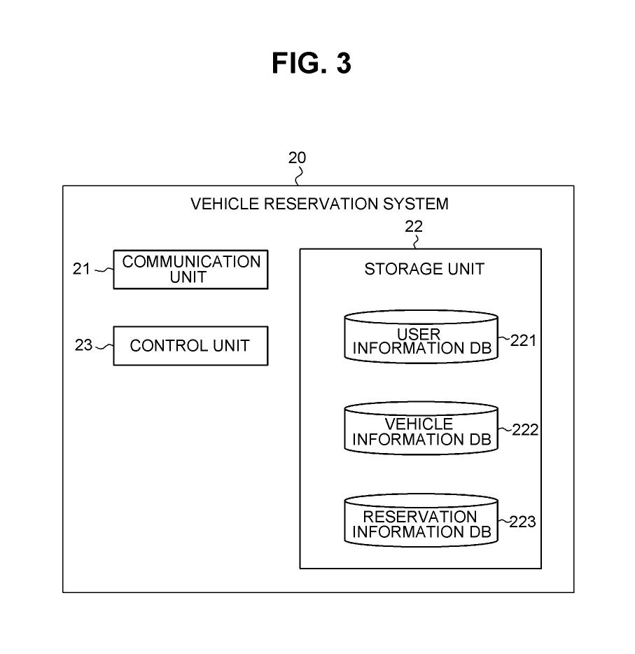

As illustrated in FIG. 3, the vehicle reservation system 20 is configured to include a communication unit 21, a storage unit 22, and a control unit 23.

The communication unit 21 includes a communication module connected to the network 40 in a wired or wireless manner. In the present embodiment, the vehicle reservation system 20 is connected to the network 40 via the communication unit 21.

The storage unit 22 includes one or more memories. Each memory included in the storage unit 22 may function as, for example, a primary storage device, a secondary storage device, or a cache memory. The storage unit 22 stores any information used for an operation of the vehicle reservation system 20. For example, the storage unit 22 may store a system program, an application program, and a database. The information stored in the storage unit 22 may be updated with, for example, information acquired from the network 40 via the communication unit 21.

In the present embodiment, the storage unit 22 stores a user information database 221, a vehicle information database 222, and a reservation information database 223.

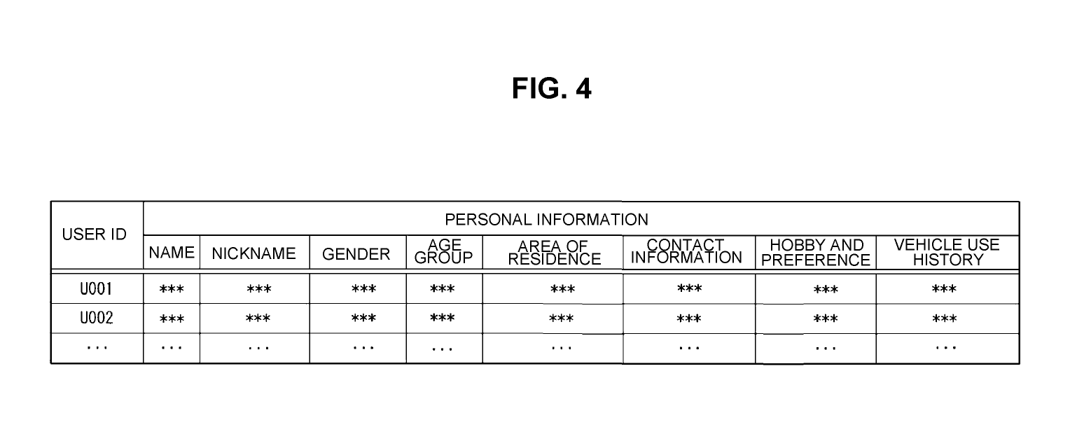

As illustrated in FIG. 4, the user information database 221 stores, for example, a user ID and personal information of each user who uses the vehicle-sharing service. Examples of the personal information include items, such as a name, nickname, gender, age group, area of residence, contact information, hobby and preference, and vehicle use history, but the personal information is not limited thereto, and may include any item associated with the user.

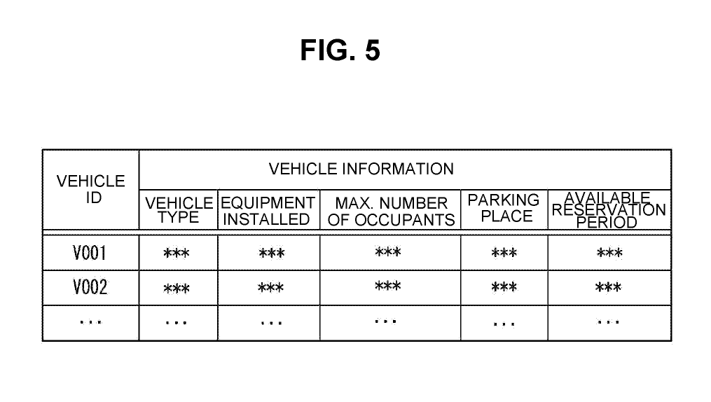

As illustrated in FIG. 5, the vehicle information database 222 stores, for example, a vehicle ID and vehicle information of each vehicle. The vehicle ID is information with which the vehicle can be uniquely identified. Examples of the vehicle information include items, such as a vehicle type, equipment installed in the vehicle, maximum number of occupants, parking place, and available reservation period, but the vehicle information is not limited thereto, and may include any item associated with the vehicle.

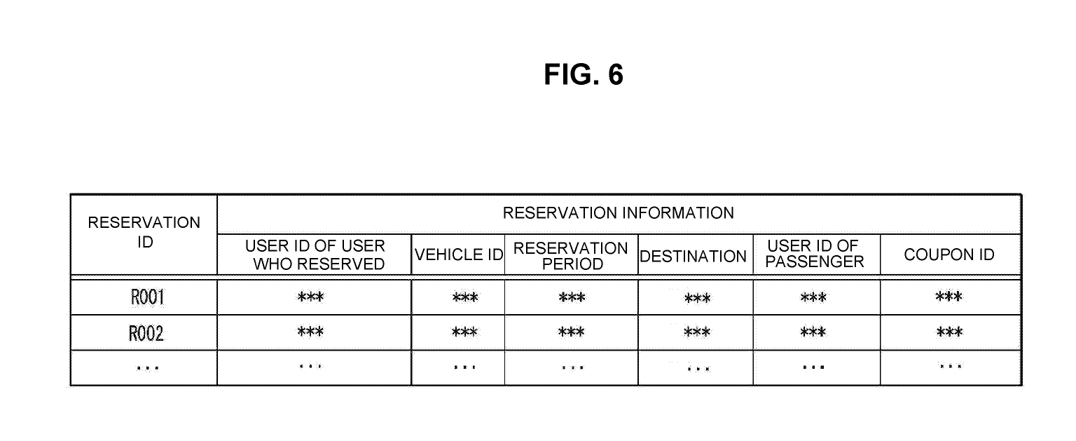

As illustrated in FIG. 6, the reservation information database 223 stores, for example, a reservation ID and reservation information of each reservation received from the user who reserved the vehicle. The reservation ID is information with which the reservation can be uniquely identified. Examples of the reservation information include items, such as a user ID of the user who reserved the vehicle, a vehicle ID of the vehicle to be used by the corresponding user, and reservation period, but the reservation information is not limited thereto, and may further include any item regarding the reservation for the vehicle to be used by the user. For example, as described below, the reservation information may further include items, such as a destination when using the vehicle, a user ID of the passenger, and a coupon ID of a coupon to be granted to the passenger.

As illustrated in FIG. 3, the control unit 23 includes one or more processors. The control unit 23 controls overall operation of the vehicle reservation system 20. Details of the operations of the vehicle reservation system 20 which are controlled by the control unit 23 will be described below.

Configuration of Coupon Management System

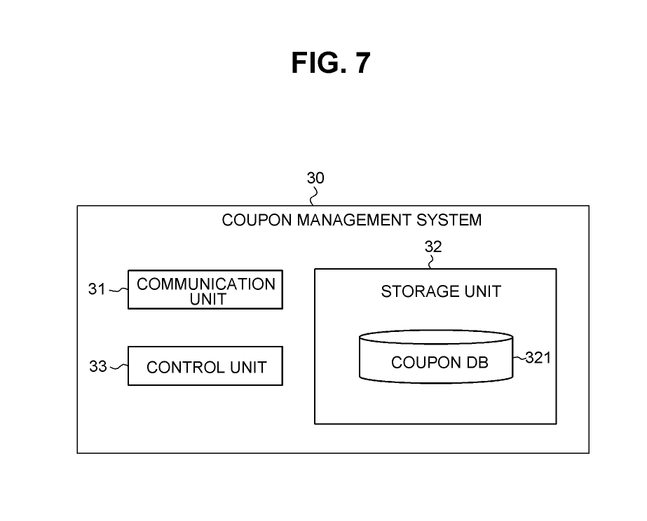

As illustrated in FIG. 7, the coupon management system 30 includes a communication unit 31, a storage unit 32, and a control unit 33.

The communication unit 31 includes a communication module connected to the network 40 in a wired or wireless manner. In the present embodiment, the coupon management system 30 is connected to the network 40 via the communication unit 31.

The storage unit 32 is configured to include one or more memories. Each memory included in the storage unit 32 may function as, for example, a primary memory unit, a secondary memory unit, or a cache memory. The storage unit 32 stores any information used for an operation of the coupon management system 30. For example, the storage unit 32 may store a system program, an application program, and a database. The information stored in the storage unit 32 may be updated with, for example, information acquired from the network 40 via the communication unit 31.

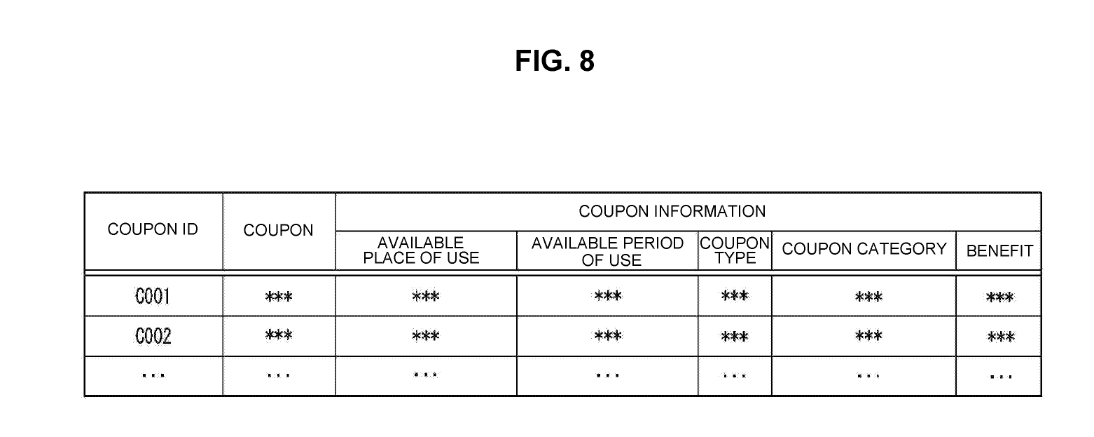

In the present embodiment, the storage unit 32 stores a coupon database 321. As illustrated in FIG. 8, the coupon database 321 stores, for example, a coupon ID of each coupon registered by a coupon registrant, each coupon, and coupon information showing the content of each coupon. The coupon ID is information with which the coupon can be uniquely identified. Examples of the coupon information include items such as a coupon name, available place of use, available period of use, type, category, and benefit, but the coupon information is not limited thereto, and may include any item associated with the content of the coupon.

As illustrated in FIG. 7, the control unit 33 includes one or more processors. The control unit 33 controls overall operation of the coupon management system 30. Details of the operations of the coupon management system 30 which are controlled by the control unit 33 will be described below.

Operations of Information Processing System

Next, details of operations of the information processing system 1 will be described.

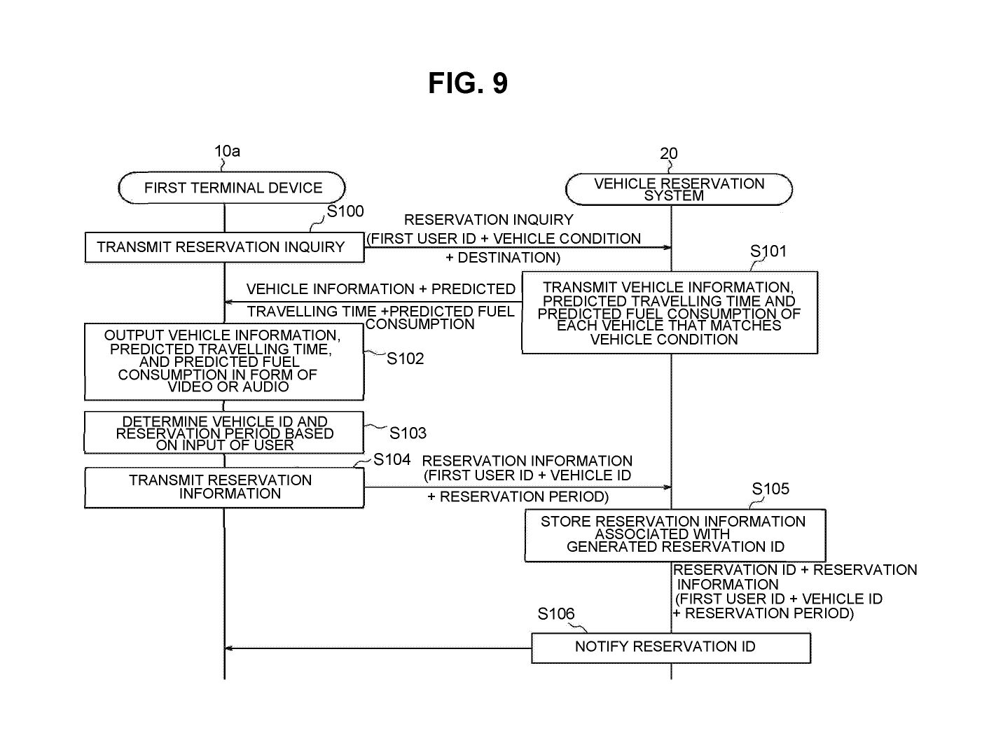

With reference to FIG. 9, a first operation of the information processing system 1 will be described below. The first operation is an operation of the information processing system 1 that is executed when the user of the terminal device 10 reserves the vehicle. Here, the user who reserves the vehicle and the corresponding user's terminal device 10 are referred to as a “first user” and a “first terminal device 10a”, respectively. In addition, the user ID and personal information of the first user are referred to as a “first user ID” and “first personal information”, respectively.

Step S100: The first terminal device 10a transmits, to the vehicle reservation system 20, a reservation inquiry on the vehicle according to the input of the first user. The reservation inquiry includes the first user ID and a vehicle condition. The vehicle condition is a condition that the first user requires the vehicle to satisfy, and may include, for example, any item described in the vehicle information, such as the vehicle type, equipment installed in the vehicle, and maximum number of occupants. The reservation inquiry is not limited to the above information, and may further include, for example, information on the destination when using the vehicle (for example, the name, address, or location information of the destination).

Step S101: In response to receiving the reservation inquiry, the vehicle reservation system 20 specifies each vehicle that matches the vehicle condition included in the corresponding reservation inquiry, from among a plurality of vehicles. The vehicle reservation system 20 extracts, from the vehicle information database 222, the vehicle ID and vehicle information of each specified vehicle, and transmits the extracted data to the first terminal device 10a. Here, when the above-described reservation inquiry includes the destination, the vehicle reservation system 20 calculates a predicted travelling time and predicted fuel consumption in travelling from the parking place to the destination of each specified vehicle, and transmits, to the first terminal device 10a, the calculated data together with the vehicle ID and the vehicle information.

Step S102: The first terminal device 10a presents, to the first user, the vehicle ID, vehicle information, predicted travelling time and predicted fuel consumption of each vehicle that have been received from the vehicle reservation system 20 by outputting them in the form of video or audio.

Step S103: The first terminal device 10a determines the vehicle ID and vehicle information of one vehicle based on the input of the first user, from among vehicle IDs and information of the vehicles presented. The first terminal device 10a determines, based on the input of the first user, a reservation period from among the available reservation periods included in the determined corresponding vehicle information.

Step S104: The first terminal device 10a transmits, to the vehicle reservation system 20, the reservation information that includes the first user ID as the user ID of the user who reserved the vehicle, and the vehicle ID and reservation period determined in step S103.

Step S105: Upon receiving the reservation information from the first terminal device 10a, the vehicle reservation system 20 generates the reservation ID. When the reservation inquiry of step S100 includes the destination when using the vehicle, the vehicle reservation system 20 adds the corresponding destination to the received corresponding reservation information. The vehicle reservation system 20 stores, in the reservation information database 223, the corresponding reservation information in association with the generated reservation ID. By storing the reservation information, the reservation made by the first user is confirmed. Specifically, the reservation in which the first user will use the vehicle having the vehicle ID shown in the corresponding reservation information during the reservation period is confirmed.

Step S106: The vehicle reservation system 20 notifies the first terminal device 10a of the reservation ID generated in step S105.

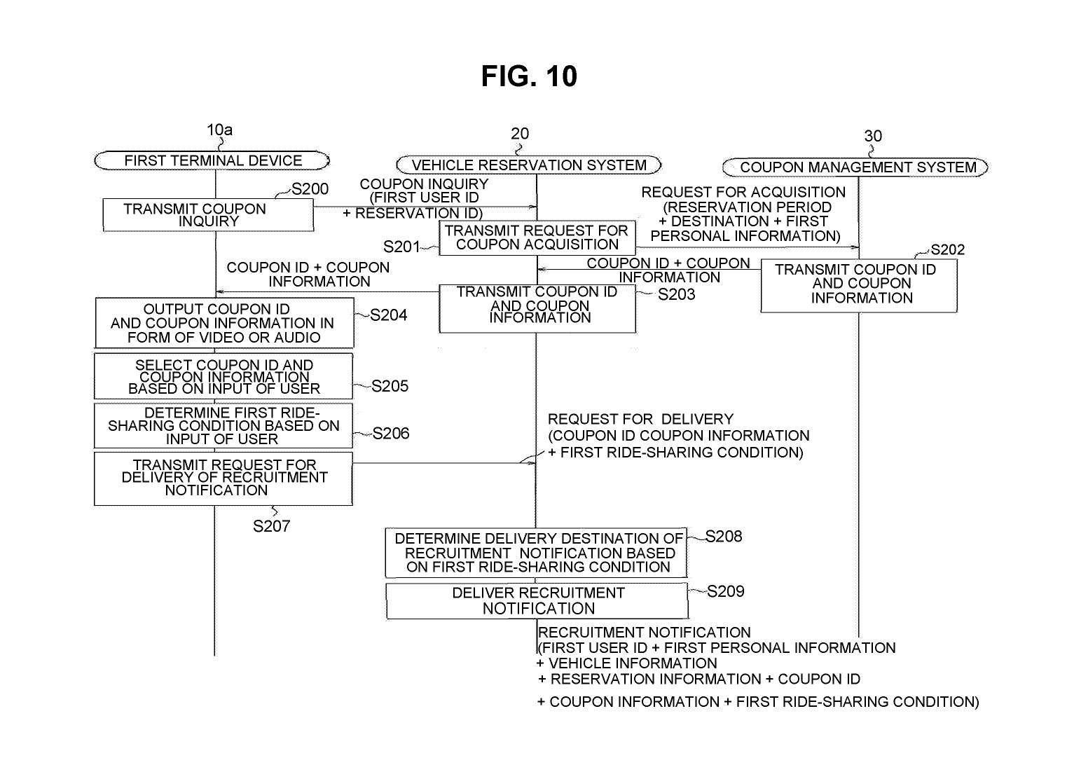

With reference to FIG. 10, a second operation of the information processing system 1 will be described below. The second operation can be executed after the above-described first operation. The second operation is an operation of the information processing system 1 that is executed when the first user recruits the passenger who will share the ride in the reserved vehicle.

Step S200: The first terminal device 10a transmits, to the vehicle reservation system 20, a coupon inquiry, according to the input of the first user. The coupon inquiry includes the first user ID, and the reservation ID showing the reservation made by the first user.

Step S201: The vehicle reservation system 20 specifies, on the reservation information database 223, the reservation information associated with the reservation ID that is included in the inquiry of step S200. The vehicle reservation system 20 extracts, from the reservation information database 223, the reservation period included in the specified reservation information. Here, when the corresponding reservation information includes the destination, the vehicle reservation system 20 further extracts the corresponding destination from the reservation information database 223. The vehicle reservation system 20 may extract, from the user information database 221, the first personal information (for example, a hobby and preference). Then, the vehicle reservation system 20 transmits, to the coupon management system 30, a request for coupon acquisition. The request for coupon acquisition includes, for example, the reservation period and destination extracted from the reservation information database 223 as described above, but is not limited thereto, and may further include the first personal information extracted from the user information database 221 as described above.

Step S202: The coupon management system 30 specifies each coupon that matches the request for coupon acquisition of step S201 within a predetermined range, from among a plurality of coupons stored in the coupon database 321. Here, “matching within a predetermined range” includes, but is not limited to, for example, satisfying at least one of a first condition in which the reservation period shown in the request for coupon acquisition, and the available period of use of the vehicle shown in the coupon information at least partially overlap with each other, and a second condition in which the distance or time distance between the destination shown in the request for coupon acquisition, and the available place of use of the coupon shown in the coupon information is below a predetermined value. For example, “matching within a predetermined range” may include satisfying at least one of the above-described first and second condition, and a third condition in which the first personal information (for example, a hobby and preference) shown in the request for coupon acquisition, and predetermined items (for example, the type or category of the coupon) included in the coupon information are identical or similar to each other. The coupon management system 30 extracts, from the coupon database 321, the coupon ID and coupon information of each specified coupon, and transmits the extracted data to the vehicle reservation system 20.

Step S203: The vehicle reservation system 20 transmits, to the first terminal device 10a, the coupon information of each coupon received from the coupon management system 30.

Step S204: The first terminal device 10a presents, to the first user, the coupon ID and coupon information of each coupon received from the vehicle reservation system 20 by outputting them in the form of video or audio.

Step S205: Based on the input of the first user, the first terminal device 10a selects the coupon IDs and coupon information of a predetermined number of coupons, from among the coupon IDs and coupon information of each coupon presented. The corresponding predetermined number of coupons is, for example, one, but may be discretionarily determined.

Step S206: The first terminal device 10a determines a first ride-sharing condition based on the input of the first user. The first ride-sharing condition is any condition that the first user requires the passenger to satisfy. Specifically, the first ride-sharing condition includes, for example, any item that can be included in the personal information stored in the user information database 221, such as gender, age group, and area of residence. However, the first ride-sharing condition is not limited thereto, and may include any item that is not necessarily included in the personal information, such as whether drop-off and pick-up is needed, and music preference while driving.

Step S207: The first terminal device 10a transmits, to the vehicle reservation system 20, a request for delivery of the passenger recruitment notification. The request for delivery includes the coupon ID and coupon information of the coupon selected in step S205, and the first ride-sharing condition determined in step S206.

Step S208: Based on the first ride-sharing condition, the vehicle reservation system 20 determines, as a delivery destination for the recruitment notification, one or more specified users from among a plurality of users using the vehicle-sharing service. Specifically, the vehicle reservation system 20 determines, as the delivery destination for the recruitment notification, one or more users, excluding the first user, who match the first user in terms of items included in the first ride-sharing condition, such as the gender, age group, and area of residence, from among the plurality of users whose personal information is stored in the user information database 221.

Step S209: The vehicle reservation system 20 pushes the passenger recruitment notification to the terminal device 10 of each user who has been determined as the delivery destination. The recruitment notification includes, for example, the first user ID, the first personal information (for example, a nickname, gender, and age group), vehicle information of the reserved vehicle (for example, the vehicle type, equipment installed in the vehicle, and maximum number of occupants), and reservation information (for example, reservation period, and destination), and the coupon ID, coupon information, and first ride-sharing condition which are included in the request for delivery in step S207. Any method can be employed for delivery of the recruitment notification. For example, the vehicle reservation system 20 delivers the recruitment notification using the contact information that is included in the personal information stored in the user information database 221. The contact information may include, for example, an e-mail address, and recipient information of a message in an external service such as a Social Networking Service (SNS).

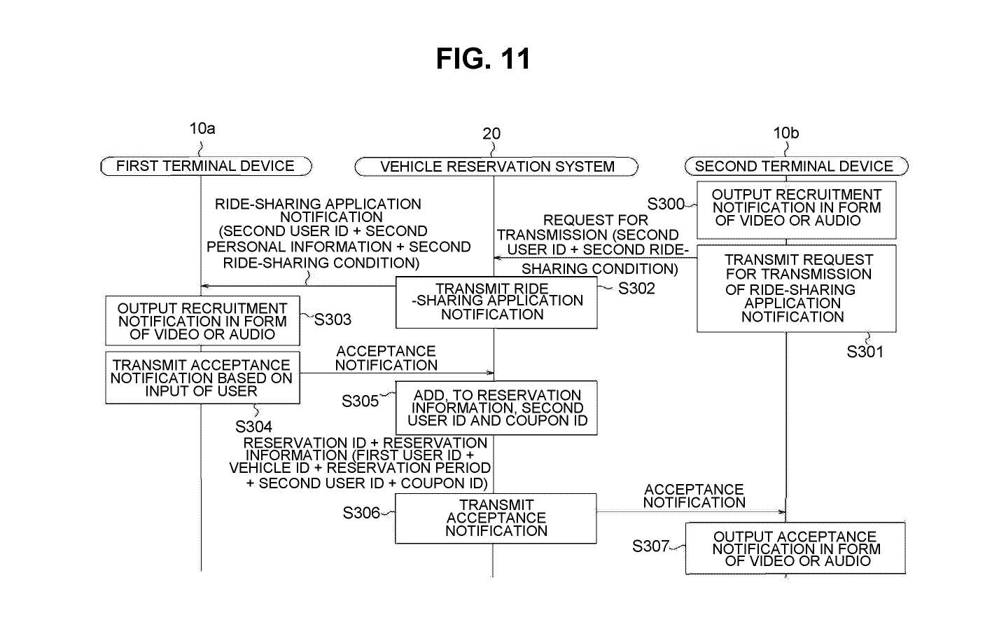

With reference to FIG. 11, a third operation of the information processing system 1 will be described below. The third operation can be executed after the above-described second operation. The third operation is an operation of the information processing system 1 that is executed when the user who has received the passenger recruitment notification from the first user applies for the corresponding recruitment. Here, the user who receives the passenger recruitment notification and a terminal device 10 of the corresponding user are referred to as a “second user” and a “second terminal device 10b”, respectively. In addition, the user ID and personal information of the second user are referred to as “second user ID” and “second personal information”, respectively.

Step S300: The second terminal device 10b presents, to the second user, the passenger recruitment notification received from the vehicle reservation system 20, by outputting the notification in the form of video or audio.

Step S301: The second terminal device 10b transmits, to the vehicle reservation system 20, a request for transmission of a ride-sharing application notification, according to the input of the second user. The corresponding request for transmission includes, but is not limited to, for example, the second user ID. For example, the second terminal device 10b may determine a second ride-sharing condition based on the input of the second user, and transmit, to the vehicle reservation system 20, the request for transmission that further includes the corresponding second ride-sharing condition. The second ride-sharing condition is any condition that the second user requires the first user. Specifically, the second ride-sharing condition can include, for example, but is not limited to, a condition of stopping off somewhere desired by the second user on the way to the destination.

Step S302: The vehicle reservation system 20 transmits, to the first terminal device 10a, the ride-sharing application notification in response to the request for transmission received from the second terminal device 10b. The ride-sharing application notification includes, for example, the second user ID and second personal information (for example, a nickname, gender, and age group), but is not limited thereto, and may further include the above-described second ride-sharing condition.

Step S303: The first terminal device 10a presents, to the first user, the ride-sharing application notification received from the vehicle reservation system 20 by outputting the ride-sharing application notification in the form of video or audio.

Step S304: The first terminal device 10a transmits, to the vehicle reservation system 20, an acceptance notification, according to an input of the first user that accepts the second user associated with the presented ride-sharing application notification as a passenger.

Step S305: According to receipt of the acceptance notification of step S304, the vehicle reservation system 20 adds, to the reservation information, the second user ID as the user ID of the passenger who will share the ride in the vehicle with the first user. The vehicle reservation system 20 adds, to the reservation information, the coupon ID included in the recruitment notification of step S209 described above, as the coupon ID of the coupon to be granted to the passenger.

Step S306: The vehicle reservation system 20 transmits, to the second terminal device 10b, the acceptance notification.

Step S307: The second terminal device 10b presents, to the second user, the acceptance notification received from the vehicle reservation system 20, by outputting the acceptance notification in the form of video or audio.

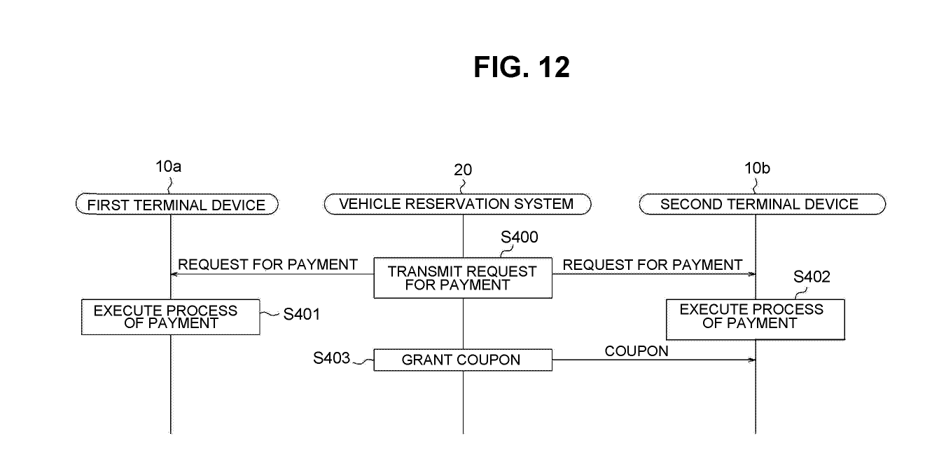

With reference to FIG. 12, a fourth operation of the information processing system 1 will be described below. The fourth operation can be executed after the above-described third operation. The fourth operation is an operation of the information processing system 1 that is executed when the first user and the second user pay a vehicle use fee.

Step S400: The vehicle reservation system 20 transmits, to the first terminal device 10a, a request for payment of a vehicle use fee P to be paid by the first user, and transmits, to the second terminal device 10b, a request for payment of a vehicle use fee Q to be paid by the second user. The vehicle use fees P and Q may be discretionarily determined. In addition, for example, the amounts of vehicle use fees P and Q may be the same or different. Moreover, for example, the sum P+Q of the vehicle use fees P and Q may be equal to or higher than a vehicle use fee R which is the amount the first user should pay when using the vehicle alone, without recruiting a passenger. Further, for example, the amount of each of the vehicle use fees P and Q may be lower than the amount of the vehicle use fee R. The amounts of vehicle use fees P, Q, and R may be determined by a provider of the vehicle-sharing service. Alternatively, the vehicle use fees P and Q may be determined by adjustment between the first user and the second user, based on the vehicle use fee R determined by the provider of the vehicle-sharing service.

Step S401: The first terminal device 10a executes a process of payment of the vehicle use fee P in response to the request for payment notified by the vehicle reservation system 20. Any method can be employed for execution of the process of payment of, including, for example, using an electronic payment system provided by a credit card company.

Step S402: The second terminal device 10b executes the process of payment of the vehicle use fee Q in response to the request for payment notified by the vehicle reservation system 20.

Step S403: Upon confirming that the process of payment of the fees has been completed by the first user and the second user, the vehicle reservation system 20 grants, to the second user, the coupon which was registered in the reservation information at the step S305 as described above. Specifically, the vehicle reservation system 20 grants the coupon to the second user by transmitting, to the second terminal device 10b, electronic data of the corresponding coupon.

As described above, in the information processing system 1 according to the present embodiment, the vehicle reservation system 20 operated by the control unit 23 stores the reservation information of the vehicle to be used by the first user, receives, from the first terminal device 10a, the coupon information of the coupon to be granted to the passenger who will share the ride in the corresponding vehicle with the first user, transmits, to one or more terminal devices 10, the passenger recruitment notification including the coupon information, transmits, to the first terminal device 10a, the corresponding ride-sharing application notification upon receiving the request for transmission of the ride-sharing application notification from the second terminal device 10b from among the corresponding one or more terminal devices 10, and adds, to the reservation information, the second user ID as the user ID of the passenger who will share the ride in the vehicle with the first user upon receiving the acceptance notification from the first terminal device 10a.

With this configuration, the user who receives the recruitment notification can acquire the coupon by sharing a ride in the vehicle with the first user. Thus, the user who receives the passenger recruitment notification can be incentivized to apply for the corresponding recruitment. Accordingly, the ride-sharing of the vehicle is promoted. In addition, since the coupon information of the coupon to be granted to the passenger is transmitted from the first terminal device 10a to the vehicle reservation system 20, the first user who uses the first terminal device 10a can select the corresponding coupon. For example, the first user selects the coupon that matches his or her personal information (for example, a hobby and preference), thereby increasing the possibility that another user having a hobby and preference similar to the first user will apply for the recruitment. Thus, the first user, who may be reluctant to share a ride with an unspecified user, for example, whose hobby and preference is not known, can be incentivized to recruit a passenger. Accordingly, the ride-sharing of the vehicle is further promoted. In addition, since the coupon information, together with the passenger recruitment notification, is pushed to a plurality of users, the users have more opportunities to acquire a coupon about which the corresponding users did not previously know, and as such, the use of vehicle-sharing service and the ride-sharing are promoted.

The present disclosure was described with reference to the drawings and the embodiment as above. However, it is to be noted that a person skilled in the art can easily make variations and modifications based on the present disclosure. Therefore, it is also to be noted that these variations and modifications fall within the scope of the present disclosure. For example, functions, and the like, included in each element, each step, or the like, can be rearranged so as not to be logically contradictory, and a plurality of elements, steps, or the like may be combined into one or divided.

For example, in the above-described embodiment, the vehicle reservation system 20 and the coupon management system 30 may be integrated into one server system. Alternatively, each of the vehicle reservation system 20 and the coupon management system 30 may be dispersed into a plurality of server systems.

Moreover, in the above-described embodiment, the provider of the vehicle-sharing service may charge an advertising fee to the coupon registrant. The advertising fee may be determined by any method. For example, the advertising fee may be determined based on information, such as the number of coupon registrations, the number of times the coupon information is presented to the users, the number of times the users access the coupon information, and the number of coupon uses. In such cases, the vehicle reservation system 20 may notify such information to the coupon management system 30, and the coupon management system 30 may store, in the coupon database 321, such information together with the coupon information and determine the advertising fee.

Further, in the above-described embodiment, the configuration in which the coupon management system 30 specifies each coupon in which the destination of the first user when using the vehicle matches the available place of use of the coupon information within a predetermined range, from among the plurality of coupons, is described. However, when the destination of the first user is not clear, the coupon management system 30 may specify each coupon in which, instead of the destination of the first user, for example, the parking place of the vehicle shown in the vehicle information matches the available place of use of the coupon information, within a predetermined range.

Moreover, in the above-described embodiment, the configuration in which the coupon management system 30 specifies each coupon that matches the request for coupon acquisition within a predetermined range, from among the plurality of coupons, is described. However, for example, when there is no coupon that matches the request for coupon acquisition within the predetermined range, the coupon management system 30 may notify the first terminal device 10a via the vehicle reservation system 20 of the fact that there is no coupon that matches the request. In such a case, the first user may generate a new coupon and coupon information by, for example, paying a predetermined fee. Specifically, the first terminal device 10a generates the coupon and coupon information based on the input of the first user, includes the generated coupon and coupon information in the request for delivery of the recruitment notification as in the above-described embodiment, and transmits the recruitment notification to the vehicle reservation system 20. Here, the vehicle reservation system 20 may determine a generation fee of the coupon and coupon information according to the corresponding coupon and coupon information, and transmit a request for payment of the corresponding generation fee to the first terminal device 10a. The request for payment of the generation fee may be executed, for example, together with the request for payment of the vehicle use fee P to be paid by the first user.

In addition, in the above-described embodiment, the first user may recruit passengers until the number of passengers reaches the maximum number permitted for the reserved vehicle. In such a case, when the combined number of the first user and the passengers reaches the maximum number permitted for the vehicle, the vehicle reservation system 20 may transmit, to the first terminal device 10a, an instruction to prohibit further requests for transmission of the passenger recruitment notification. Upon receiving the corresponding instruction, the first terminal device 10a is controlled such that it does not receive an input of the first user executing the request for transmission of the passenger recruitment notification.

Further, in the above-described embodiment, although a description was made of the configuration in which the first user and the second user pay the vehicle use fees P and Q, respectively, the method of payment of the vehicle use fees P and Q is not limited thereto. For example, the second user may pay the vehicle use fee Q to the first user, and the first user may then pay the vehicle use fees P and Q at the same time.

In addition, in the above-described embodiment, a description was made of the configuration in which the vehicle reservation system 20 delivers the passenger recruitment notification in response to the request for delivery from the first terminal device 10a. However, the vehicle reservation system 20 may automatically deliver the recruitment notification at a discretionary time, not in response to the request for delivery from the first terminal device 10a.

Moreover, in the above-described embodiment, the first ride-sharing condition determined by the first terminal device 10a may include an item regarding ownership of a driver's license. In such a case, the vehicle reservation system 20 may deliver, to the plurality of terminal devices 10, a driver recruitment notification instead of the passenger recruitment notification.

In addition, in the above-described embodiment, upon receiving, from the second terminal device 10b, the request for transmission of the ride-sharing application notification from the second terminal device 10b, the vehicle reservation system 20 analyzes which type of coupon the second user is interested in, based on the coupon information (for example, the type and category of the coupon included in the passenger recruitment notification that has been transmitted to the corresponding second terminal device 10b, and adds the analysis result to the second user's personal information in the user information database 221. In such a case, upon receiving, from any terminal device 10, the request for transmission of the passenger recruitment notification that includes coupon information which is assumed to be highly likely to interest the second user based on the corresponding analysis result, the vehicle reservation system 20 preferentially delivers the corresponding recruitment notification to the second user.

Further, in the above-described embodiment, a description was made of the configuration in which the coupon management system 30 specifies each coupon that matches the request for coupon acquisition from the vehicle reservation system 20 within a predetermined range. Here, when a coupon matches the request for coupon acquisition in terms of some of the items included therein within the predetermined range, the coupon management system 30 may broaden the predetermined range in terms of the other items, and specify each coupon that matches the corresponding coupon acquisition request within the broader range. For example, when a hobby and preference shown in a coupon inquiry matches the type or category of a coupon shown in the coupon information, the coupon management system 30 can specify a coupon in which the distance or time distance between the available place of use of the coupon shown in the coupon information and the destination shown in the coupon inquiry is below the standard value that is longer than the predetermined value according to the above-described embodiment. Alternatively, when a hobby and preference shown in a coupon inquiry matches the type or category of a coupon, shown in the coupon information, the coupon management system 30 can specify a coupon in which the available period of use of the coupon, shown in the coupon information and the reservation period, shown in the coupon inquiry, overlap each other when one of the above two periods is lengthened. With this configuration, for example, in case a coupon is less frequently searched for than other coupons as a destination due to a factor such as low awareness thereof according to the coupon information and is thus less likely to be used, it is possible that the first user will change his or her desired destination or reservation period and select the coupon even though the destination or reservation period of the coupon is slightly different from his or her desired destination or reservation period, since the coupon matches the hobby and preference of the first user.

In addition, in the above-described embodiment, the vehicle reservation system 20 may calculate a predicted date and time of the first user's arrival at the destination, based on the reservation period and destination included in the reservation information of the first user and the parking place of the vehicle to be used by the first user. In such a case, the vehicle reservation system 20 may notify, of the corresponding predicted date and time of arrival, the registrant of the coupon to be granted to the second user who will share the ride with the first user.

Moreover, in the above-described embodiment, a description was made of the configuration in which, according to receipt of the acceptance notification from the first terminal device 10a, the vehicle reservation system 20 adds, to the reservation information, the second user ID and the coupon ID. However, for example, when the second ride-sharing condition is not included in the request for transmission of the ride-sharing application notification that the vehicle reservation system 20 received from the second terminal device 10b, the vehicle reservation system 20 may add, to the reservation information, the second user ID and the coupon ID without receiving the acceptance notification from the first terminal device 10a.

Further, general-purpose electronic equipment may function as the terminal device 10, the vehicle reservation system 20, and the coupon management system 30 according to the above-described embodiment. Specifically, a program that describes processing details for implementing each function of the terminal device 10, the vehicle reservation system 20, and the coupon management system 30 according to the present embodiment is stored in a memory of the electronic equipment, and the corresponding program is read and executed by a processor of the electronic equipment. Accordingly, the disclosure according to the present embodiment can also be implemented as a program executable by a processor.

What is claimed is:

1. A server system comprising:
a communication unit including one or more communication modules;
a storage unit including one or more memories; and
a control unit including one or more processors,
wherein the control unit is configured to:
store, in the storage unit, reservation information of a vehicle to be used by a first user;
receive, from a first terminal device of the first user via the communication unit, coupon information showing content of a coupon to be granted to a passenger who will share a ride in the vehicle with the first user;
deliver, to one or more terminal devices via the communication unit, a passenger recruitment notification including the coupon information;
upon receiving a request for transmission of a ride-sharing application notification from a second terminal device from among the one or more terminal devices via the communication unit, transmit the ride-sharing application notification to the first terminal device via the communication unit; and
add, to the reservation information, a user ID of a second user of the second terminal device as a user ID of the passenger who will share the ride in the vehicle with the first user.

2. The server system according to claim 1, wherein the control unit is configured to add the user ID of the second user to the reservation information upon transmitting the ride-sharing application notification to the first terminal device and receiving a request for acceptance from the first terminal device via the communication unit.

3. The server system according to claim 1, wherein:
the control unit is configured to transmit one or more pieces of coupon information to the first terminal device via the communication unit; and,
the coupon information received from the first terminal device is selected, based on an input of the first user to the first terminal device from among the one or more pieces of coupon information.

4. The server system according to claim 3, wherein the one or more pieces of coupon information is extracted from among a plurality of pieces of coupon information, based on at least one of a destination of the first user when using the vehicle, a reservation period of the vehicle, and personal information of the first user.

5. The server system according to claim 1, wherein the coupon information received from the first terminal device and the coupon shown in the coupon information are generated based on an input of the first user to the first terminal device.

6. The server system according to claim 5, wherein the control unit is configured to transmit, to the first terminal device via the communication unit, a request, to the first user, for payment of a generation fee of the coupon information.

7. The server system according to claim 1, wherein according to completion of a process of payment of a use fee of the vehicle, based on the reservation information, the control unit is configured to grant, to the second user, the coupon corresponding to the coupon information included in the recruitment notification.

8. A method of controlling a server system configured to communicate with a plurality of terminal devices, the method comprising:
storing reservation information of a vehicle to be used by a first user;
receiving, from a first terminal device of the first user, coupon information showing content of a coupon to be granted to a passenger who will share a ride in the vehicle with the first user;
delivering, to one or more terminal devices, a passenger recruitment notification including the coupon information;
upon receiving a request for transmission of a ride-sharing application notification from a second terminal device among the one or more terminal devices, transmitting the ride-sharing application notification to the first terminal device; and
adding, to the reservation information, a user ID of a second user of the second terminal device as a user ID of the passenger who will share the ride in the vehicle with the first user.

9. A non-transitory computer-readable medium storing a program to cause a terminal device to execute a process, wherein the terminal device includes a communication unit including one or more communication modules, an output unit including one or more output interfaces configured to output information in a form of video or audio, an input unit including one or more input interfaces configured to detect an input of a user, and a control unit including one or more processors, the process comprising:
transmitting, to a vehicle reservation system, reservation information of a vehicle according to the input of the user;
transmitting, to the vehicle reservation system, coupon information showing content of a coupon to be granted to a passenger who will share a ride in the vehicle with the user of the terminal device; and
outputting a ride-sharing application notification in the form of video or audio, upon receiving the ride-sharing application notification transmitted by the vehicle reservation system in response to a transmission request from a second terminal device that has received a passenger recruitment notification including the coupon information from the vehicle reservation system.
